(19) United States
(12) Patent Application Publication
(10) Pub. No.: US 2009/0159220 A1
(43) Pub. Date: Jun. 25, 2009

(54) BALLASTED WIND SHIELDING SYSTEM AND METHOD

(75) Inventor: William W. Henning, Sarasota, FL (US)

Correspondence Address: MATTHEW R. JENKINS, ESQ., 1205 MANATEE AVENUE WEST, BRADENTON, FL, 34205, US

(73) Assignee: AER-FLO CANVAS PRODUCTS, INC., Oneco, FL (US)

(21) Appl. No.: 12/394,501

(22) Filed: Feb. 27, 2009

Related U.S. Application Data
(62) Division of application No. 11/291,754, filed on Dec. 1, 2005.

(51) Int. Cl. E06B 9/52

(52) U.S. Cl. 160/330

(57) ABSTRACT

A system, apparatus and method for shielding an area from wind is shown. The system, apparatus and method comprise at least one or a plurality of windscreens that yield to a wind to facilitate or reducing or eliminating stresses or forces on a fence to which the at least one or a plurality of windscreens are attached.

### CROSS-REFERENCE TO RELATED APPLICATION

This application is a division of Ser. No. 11/291,754, filed Dec. 1, 2005, which is made a part hereof and incorporated herein by reference.

### BACKGROUND OF THE INVENTION

1. Field of the Invention

This invention relates to a ballasted system and method for shielding an area from wind, and more particularly, to at least one or a plurality of ballasted windscreens that may be situated on a support or fence to protect an area from wind and to facilitate reducing or eliminating damage that may occur to the windscreens, supports or the fence to which it is attached.

2. Description of the Related Art

In an outdoor environment, windscreens are commonly used to break up gusting winds, to provide an improved background for a better vision of a ball during a sporting event or practice, such as baseball, tennis, softball and the like, and to minimize distraction for players of sports. Windscreens consist of various woven or otherwise assembled fabrics that can allow approximately 10% to 50% of wind to pass through the material. Prior art windscreens are attached to fence material, usually chain link fences, around the entire perimeter on one side of the fence.

It is well known by sport facilities management personnel (particularly for tennis, baseball, softball and soccer) and by chain link fence construction personnel that after the prior art windscreen is installed, the fence or windscreen can experience wind velocities of 50 mph or more. When sustained wind velocities surpass this threshold, damage to either the windscreen or fence, or both, is almost assured. Damage to the windscreen can cost the replacement of the windscreen and labor. Damage to the fence can cost the replacement of the fence due to the non-repairable nature of the steel pipe posts usually used with the chain link fences when they are bent. The cost of labor is high for both the original installation of the windscreen onto the fence and for the replacement of the windscreen and fence.

At the present time, there is no means, system or method available that allows windscreen that is installed on a fence, such as a chain link fence, to survive high wind velocities (such as sustained winds over 50 mph) or to not damage the fence to which the windscreen is attached, other than by removing the windscreen from the fence prior to the high winds, but this is not practical often times because the winds can be unexpected or sudden, or needed labor is not readily available.

At the present time, the installation of the prior art windscreens requires full attachment around the full perimeter of the windscreen. This is a slow, labor intensive and costly task. If a prior art windscreen is blown off the fence, for example, it requires equally costly reattachment. Another problem with the prior art windscreens is that the procurement of a prior art windscreen typically required the taking of very exacting dimensions and measurements of the fence prior to obtaining the windscreen. This is because the prior art is constructed typically in long segments of windscreen material, typically 60 to 20 feet in length, and they were typically exactly fitted to the fences to which they were attached in order to be fully functional. The custom fabrication and measurements required for the prior art windscreens resulted in very slow delivery times after a user placed an order for the windscreen. For example, a typical delivery time would be 4 to 6 weeks after an order is placed during a peak ordering season, such as February through April.

There is, therefore, a need for a high wind tolerant windscreen apparatus, system and method that is easy to deploy and facilitates protecting the fence or windscreen to which it is attached and facilitates preventing damage to the windscreen and the fence.

### SUMMARY OF THE INVENTION

It is therefore an object of the invention to provide a system and method for facilitating reducing damage to a windscreen and a fence.

Another object of one embodiment of the invention is to provide a system and method that permits high winds to pass through a fence, without damaging the windscreen or the fence.

Still another object is to provide an improved system and method for installing windscreens.

Another object of another embodiment of the invention is to provide a windscreen that is only attached to the fence at a distance from its top edge.

Yet another object of another embodiment is to provide a system and method that facilitates installing a windscreen and reduces or eliminates the requirements to take exacting dimensions of an area or fence onto which the windscreen is attached.

Yet another object of another embodiment is to provide a system and method including at least one windscreen that would yield to a wind of predetermined velocity, thereby facilitating reducing the forces and stresses on a fence.

Another object of the invention is to provide windscreen having a ballast or weight, with such weight being permanent or variable.

In one aspect, one embodiment relates to a wind shielding system for mounting on a fence having a first side and a second side, the wind shielding system comprising a first flexible sheet material having a first ballast comprising a first predetermined weight, and a second flexible sheet material having a second ballast comprising a second predetermined weight, the first and second flexible sheet material being arranged on the fence in a predetermined order to facilitate protecting an outdoor area from wind.

In another aspect, another embodiment relates to a windscreen for mounting onto a fence, the windscreen comprising: a flexible sheet material, and a ballast associated with the flexible sheet material for permitting the flexible sheet material to yield to an oncoming wind when the oncoming wind exceeds a predetermined velocity.

In yet another aspect, this invention relates to a method for reducing forces on a fence surrounding a fenced area that is desired to be at least partially protected from wind, the method comprising the step of: providing a plurality of windscreens for situating in a predetermined order on the fence, wherein the predetermined order is such that a first one of the plurality of windscreens is located on a first side of the fence and a second one of the plurality of windscreens is located on a second side of the fence. Other ones of said plurality of windscreens may repeat the order alternating on the first and second sides of the fence.

In still another aspect, this invention relates to a method for screening an area from wind, the method comprising the steps of: fastening a windscreen on the fence such that the windscreen yields leeward away from the fence.

In yet another aspect, this invention relates to a system for screening an area from winds comprising a plurality of windscreens, at least one support on which the plurality of windscreens may be mounted such that at least one of the plurality of windscreens yields to a wind while others of the plurality of windscreens do not.

Another object is to provide a windscreen system and method that have one or more of the aforementioned features alone or in combination with one or more of the other features.

These and other objects and advantages of the invention will be apparent from the following description, the accompanying drawing and the appended claims.

### BRIEF DESCRIPTION OF ACCOMPANYING DRAWING

FIG. 1 is a perspective view of a windscreen apparatus and system according to one embodiment of the invention;

FIG. 2 is another perspective view of a windscreen system apparatus and method, illustrating a plurality of the windscreens yielding leeward or downwind in response to a wind;

FIG. 3 is another perspective view showing a plurality of the windscreens overlapping a common area of the fence;

FIG. 4 is a perspective view illustrating the various plurality of windscreens at various stages of retraction;

FIG. 5 is a vertical cross-section taken along the line 5-5 in FIG. 2 illustrating a causing of one of the windscreens to yield;

FIG. 6 is a view similar to FIG. 5 illustrating the wind coming from the opposite direction of that shown in FIG. 5 and illustrating another windscreen moving in a leeward or opposite direction of that shown in FIG. 5;

FIG. 7 is a front view of a windscreen in accordance with one embodiment of the invention illustrating various features of the embodiment shown in FIG. 9;

FIG. 8 is a side view of the windscreen shown in FIG. 7;

FIG. 9 is a fragmentary front view of said windscreen;

FIG. 10 is a vertical cross-section taken along line 10-10 of FIG. 9;

FIG. 11 is a view illustrating at least one fastener accordance with the embodiment of the invention;

FIG. 12A-12B illustrate the process for fastening the at least one fastener onto a fence, thereby securing the windscreen;

FIG. 13 is a top view of the embodiment shown FIG. 7;

FIG. 14 is a rear view of the embodiment shown FIG. 7;

FIG. 15 is a bottom view of the embodiment shown FIG. 7;

FIG. 16 is a view illustrating the plurality of windscreens in a predetermined configuration which is different from that shown FIGS. 1 -4;

FIG. 17 is a view showing a plurality of windscreens on a common side of a fence and also illustrating a gap distance between adjacent windscreens;

FIG. 18 is an illustration showing a separately attachable pocket into which a ballast or weight may be situated;

FIG. 19 is a front view of another embodiment;

FIG. 20 is a sectional view taken along the line 20-20 in FIG. 19;

FIGS. 21-22 are views of other embodiments of the invention showing the windscreens having a configuration or shape other than rectangular;

FIG. 23 is a perspective view of another embodiment of the invention illustrating a plurality of pockets and/or ballast on vertical sides of the windscreens;

FIG. 24 is another view of a windscreen situated at a top edge of a fence, rather than drop below the top edge as illustrated in other embodiments.

### DETAILED DESCRIPTION OF PREFERRED EMBODIMENT

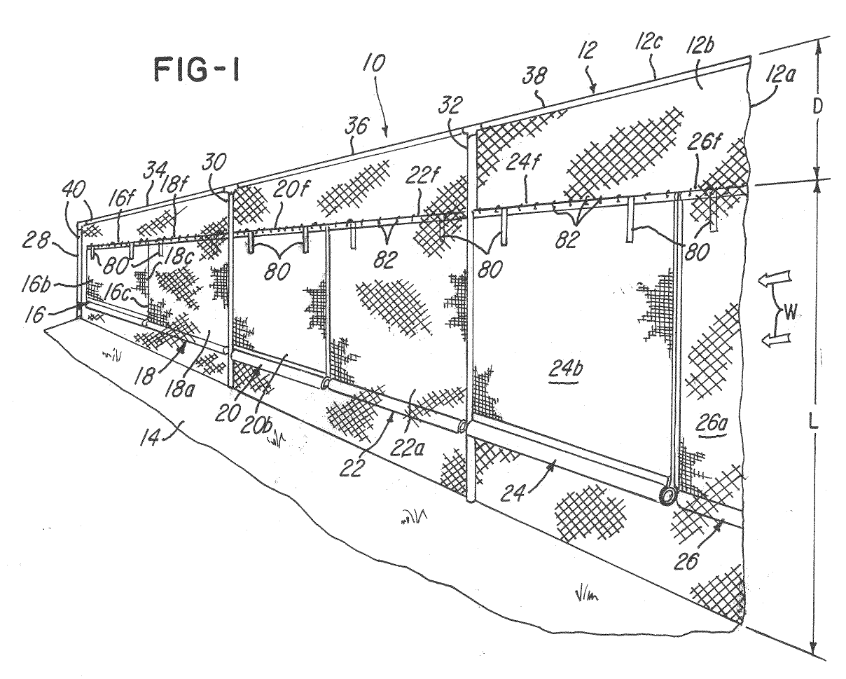

Referring now to FIGS. 1-24, a wind shielding apparatus, system 10, and method will now be described. In one embodiment, the wind shielding system 10 and method facilitates reducing wind forces and stresses on a fence 12 surrounding a sporting or fenced area 14 (such as tennis, baseball, basketball, soccer, and the like) that is desired to be at least partially or fully protected from wind W.

In one embodiment, the wind shielding system 10 comprises at least one or a plurality of flexible sheet materials, windscreens or sheets, such as the first flexible sheet or windscreen 16, second flexible sheet or windscreen 18, third flexible sheet or windscreen 20, fourth flexible sheet or windscreen 22, fifth flexible sheet or windscreen 24, and sixth flexible sheet or windscreen 26. For ease of discussion, each flexible sheet material or windscreen will be referred to as a windscreen. Although the illustration is being described with reference to six windscreens 16-26, it should be understood that the system 10 could comprise one or N number of flexible sheet materials or windscreens. Thus, it should be understood that although the embodiment shown in FIG. 1 illustrates the wind shield system 10 comprising six flexible sheets, the invention is not limited to that number of sheets and more or fewer sheets could be used or even a single sheet may be used depending upon the application or environment in which the invention is being used. For ease of description, the system 10 will be described relative to the example embodiment shown in FIG. 1, but it should be understood that more or fewer windscreens N may be used.

Advantageously, the system 10 and method described herein provides a high wind tolerant windscreen system 10 that allows wind traveling at a predetermined velocity to pass through the fence 12 or a portion of a fence 12 without damaging either the windscreens 16-26 or the fence 12.

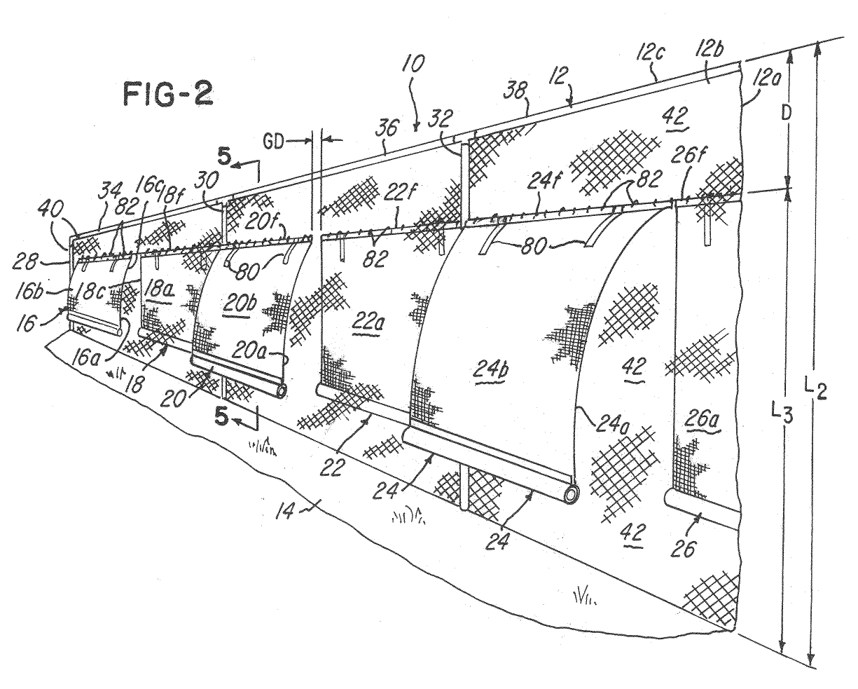

In the illustration shown in FIGS. 1 and 2, the fence 12 is a chain-link fence, but the system 10 may be used on other types of fences (not shown), or any wire fence. Note that the fence 12 is supported by a plurality of vertical posts or supports 28, 30, and 32 and horizontal supports 34, 36, and 38 that cooperate to define a frame 40 for holding or supporting the chain link fence as shown. The vertical posts 28, 30 and 32 are typically spaced about 10 feet apart. In the embodiment being illustrated in FIGS. 1 and 2, the size and shape of the vertical posts or supports 28, 30 and 32 and horizontal supports 34, 36 and 38 may vary depending on a size of the fence, height, typical wind forces and the like. Although not shown, it should be understood that the system 10 and method may be used with other types of fences and the fence 12 that does not have to use the horizontal supports 34, 36 and 38 between the vertical posts or supports 28, 30 and 32.

Note that the windscreens 16-26 are arranged in a predetermined order, configuration or position on at least one of a first side 12a or a second side 12b of the fence 12. The windscreens 16-26 are arranged in the predetermined order on the fence 12 to facilitate protecting the area 14 from wind W. In the illustrations shown in FIGS. 1 and 2, for example, the predetermined order comprises a staggered configuration, with the windscreens 18, 22 and 26 placed on side 12a and windscreens 16, 20 and 24 placed or mounted on side 12b of the fence 12. In this particular example, every other windscreen is placed on an opposite side of the first side 12a or the second side 12b of fence 12.

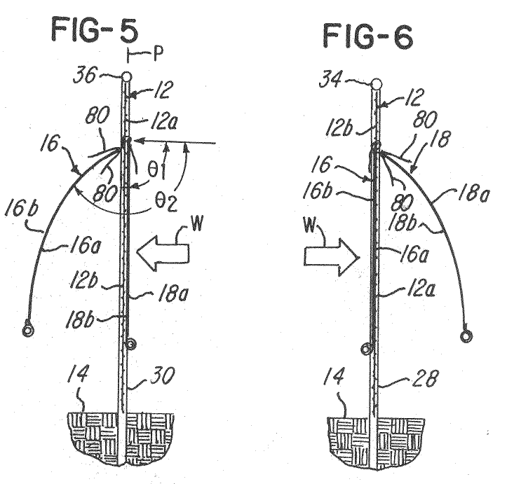

It should be understood that the predetermined order or arrangement of the windscreens 16-26 is based upon various factors, including but not limited to, the common or typical direction of the wind, typical wind velocity, gusting wind velocity, size or strength of supports 28-38, height of fence 12, surrounding terrain, buildings and obstacles, landscaping, fence location or other factors that may influence wind direction toward or away from the fence 12 and the like. Returning to the illustration in FIGS. 1-2, note that the windscreens 16-26 are arranged in a staggered configuration such that windscreens 18, 22, and 26 are arranged on the first side 12a of the fence 12 and windscreens 16, 20, and 24 are arranged on the opposite or second side of 12b of the fence 12. When the wind approaches the fence 12 from the first side 12a (that is, from the right as viewed in FIGS. 1 and 5), the windscreens 16, 20 and 24 yield leeward or downwind as illustrated in FIG. 5. When the wind velocity comes from the opposite direction or side 12a, as illustrated in FIG. 6, then the windscreens 18, 22 and 26 yield leeward or downwind when the wind exceeds the predetermined velocity.

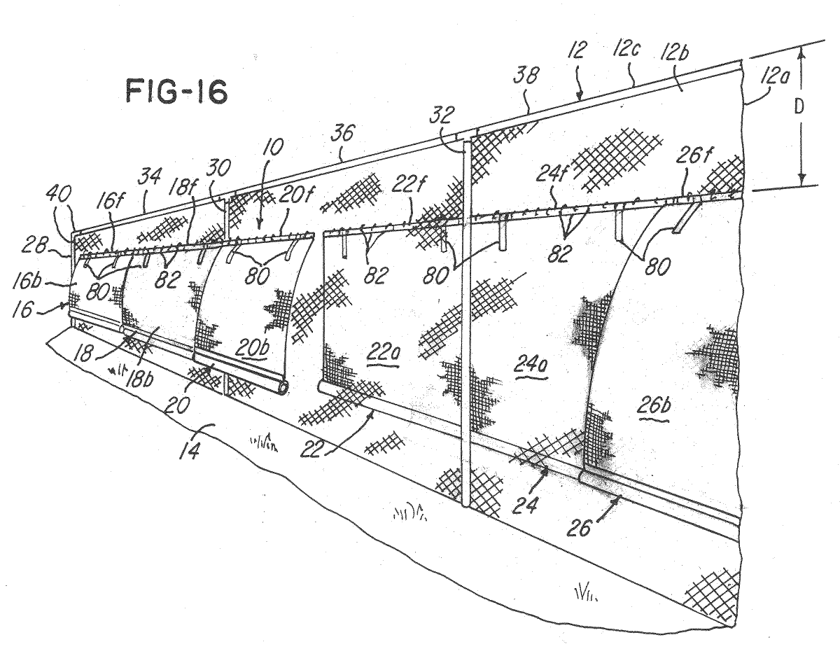

It should be understood that at least one or a plurality of windscreens, such as 16-26, do not have to be located in the staggered configuration illustrated in FIGS. 1-4, but could be located in any configuration or order depending on the environment in which they are used. For example, FIG. 16 illustrates an embodiment wherein the windscreens 16-20 are arranged adjacently and on the side 12b of the fence 12 and at a common distance D (FIGS. 1 and 16) from a top 12c of the fence 12. The next two windscreens 22 and 24 are arranged on the first side 12a of fence 12, and the sixth screen 26 arranged again on the second side 12b. FIG. 17 illustrates yet another embodiment wherein in all of the windscreens 16-26 are arranged on a common side, such as second side 12b. Thus, it should be understood that the predetermined order or configuration can change as desired in response to the environment and wind conditions in which the system 10 is used.

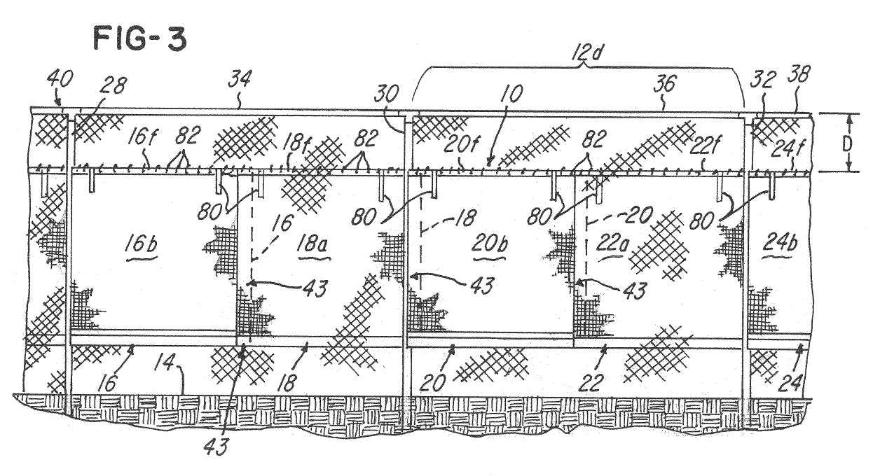

The entire chain link fence 12 does not have to be covered with windscreens. In a preferred embodiment, less than 100%, but greater than 50% of the entire surface area 42 (FIG. 2) of the fence 12 or a section of the fence 12, such as the section 12d (FIG. 3) between posts or supports 30 and 32, may be covered with one or more of the windscreens, such as windscreens 20 and 22, as shown.

Accordingly, it is important to understand that the predetermined order, number, arrangement and selection of the windscreens or sheet material will vary depending on the environment in which the system 10 is used and on such factors including the size of the fence 12 and its components, the predominate wind direction, mounting height, area of fence 12 covered, wind velocity, wind direction relative to the fence 12, and the like. For example, for a tennis court located next to a beach where a predominate wind is typically inland, it may be desirable to situate a majority of the plurality of windscreens 16-26 on the downwind or leeward side (side 12b in FIG. 2, for example) of the fence 12, with a predetermined gap distance GD (FIG. 17) between one or more of them, both of which facilitates reducing stress on the fence 12.

Referring now to FIGS. 5 -15, various features of the windscreens 16-26 will be described and shown. For ease of discussion, the features will be described relative to windscreen 16, but it should be understood that each of these windscreens 16-26 comprise the same or substantially similar parts.

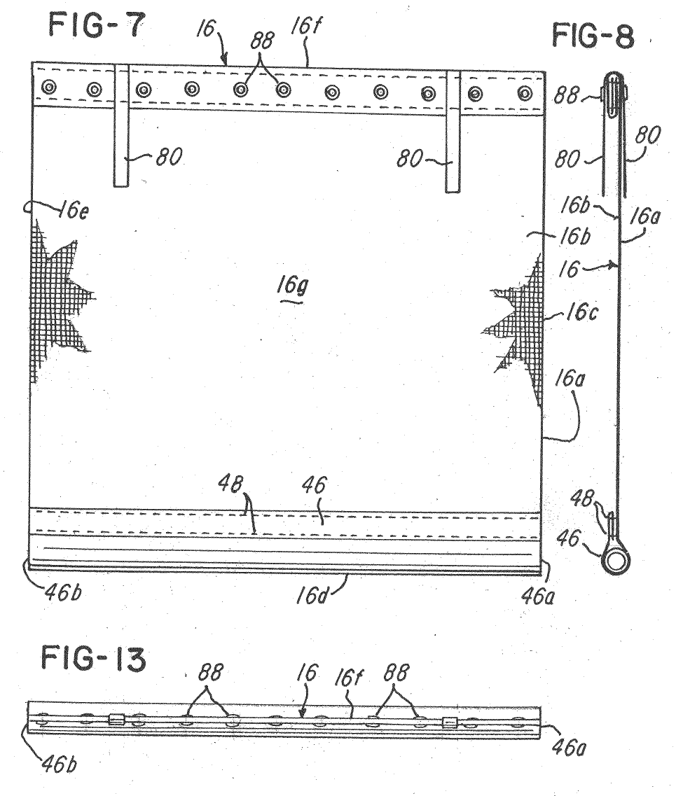

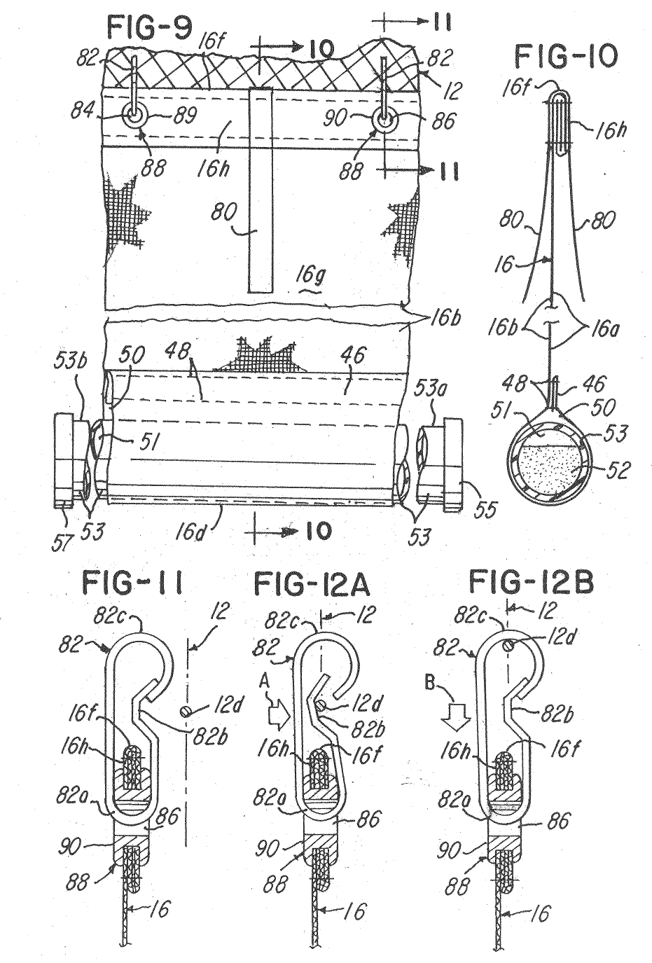

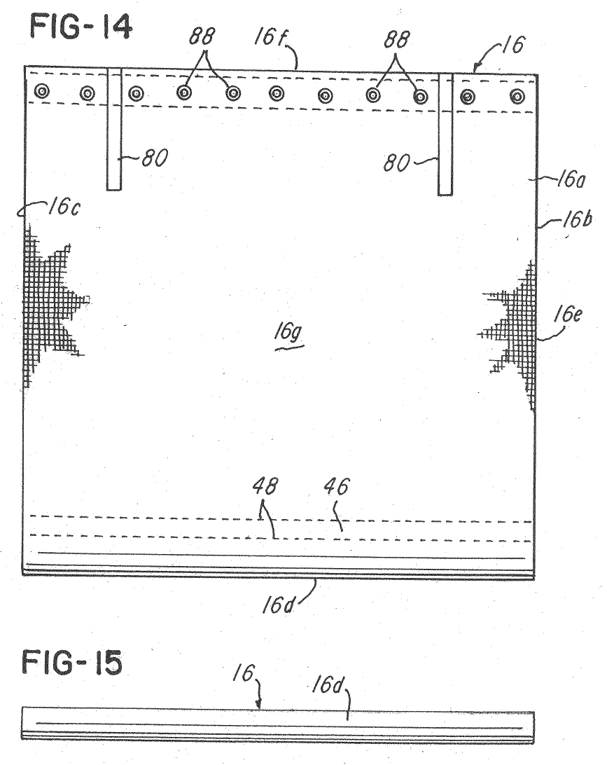

As illustrated in FIGS. 7 and 8, the windscreen 16 comprises first side edge 16c, a bottom edge 16d, a second side edge 16e and a top edge 16f as shown. The windscreen 16 further comprises a hem 46 that is formed, as shown in FIGS. 10 and 14, by gathering or folding the windscreen 16 upon itself (FIG. 10) and providing one or more stitches 48 or other means for securing windscreen 16 to form the hem 46. Note that the hem 46 forms, provides or defines a ballast pocket or receiving area 50 (FIGS. 9 and 10) for receiving ballast material or weight 52 to facilitate providing stability and ballast to the windscreen 16 after it is mounted onto the fence 12. The ballast or weight 52 may be placed directly in the receiving area 50 and one or both ends 46a and 46b (FIG. 7) of hem 46 stitched (not shown) to seal the hem 46.

In other embodiments, a tube, pipe, rod, steel, wood member, or container 53 may be inserted into the receiving area 50. As shown in FIGS. 9 and 10, container 53 may comprise removable caps, lids or ends 55 and 57 that are press fit onto the ends 53a and 53b, respectively, of container 53. The container 53 itself may provide ballast or weight 52 and/or it may provide a receiving area 51 for receiving ballast or weight 52. Thus, it should be understood that the ballast or weight may be provided by the container 53 itself or any suitable means for providing weight or ballast, such as sand, metal, chain, pipe, or the like to the bottom 16d of windscreen 16. As mentioned earlier, the container 53 may define or provide a storage container or means that is adapted to receive a pre-selected amount of ballast material, such as the ballast material 52 in FIG. 10. In this regard, the amount of ballast material or weight 52 (FIG. 10) situated in receiving areas 50 of hem 46 and/or 51 of container 53 may be changed so that resilience or resistance of the windscreen 16 to an oncoming wind force can be adjusted.

Thus, it should be understood that the ballast container 53 may integrally provide the ballast or weight material 52 in the receiving area 50 or it may provide the sealed container 53 having the area 51 (FIG. 10) for receiving ballast or weight 52. The removable caps or lids 55 and 57 (FIG. 10) may be provided to seal the area 51 for sealing ballast container 53 so that when material ballast or weight 52 is received in the area 51 of ballast container 53, it does not escape. As mentioned earlier, however, it should be understood that no container 53 may be used if desired and the hem pocket or receiving area 50 of hem 46 itself may directly receive ballast or weight 52, such as the sand, chain, without the use of the ballast container 53 as desired.

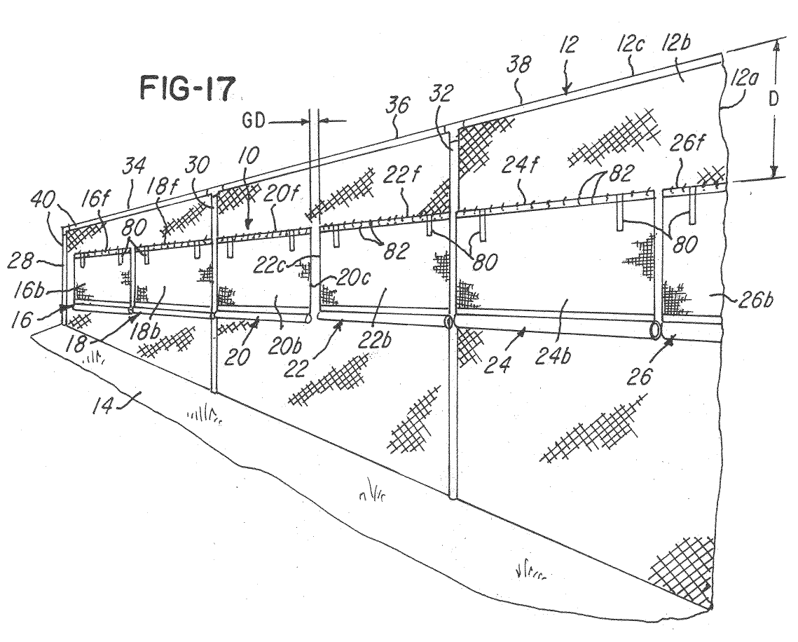

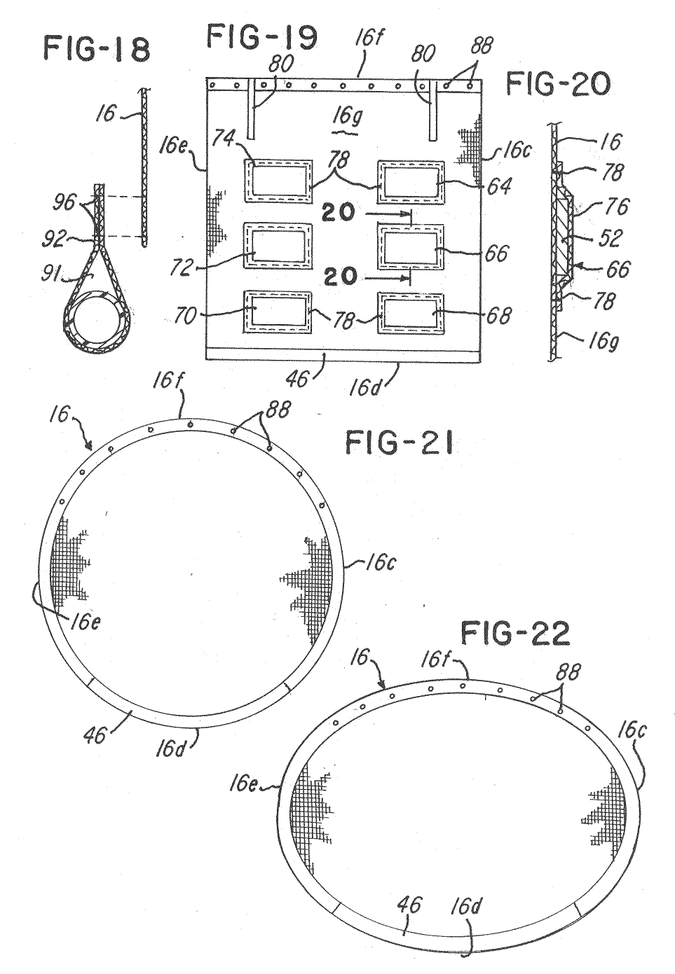

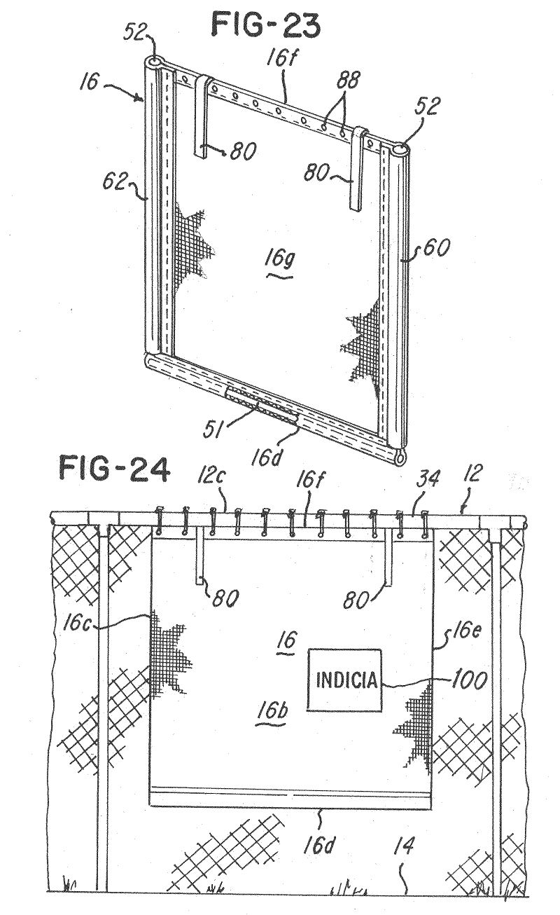

For ease of illustration, features of the present discussion presumes the hem 46 has the container 53 in the receiving area 50, but as mentioned earlier, other means and methods for providing and/or storing the weight could be provided. As best illustrated in FIGS. 9, 10, 12, 13, and 14, notice that the ballast container 53 and ballast pocket 50 in hem 46 are situated at the bottom area or edge 16d of the windscreen 16. However, a plurality of pockets or hems could be provided. For example, FIG. 23 illustrates one or more vertical hems or pockets 60 and 62 for receiving the ballast or weight material 52. FIGS. 18 and 19 illustrate the interior area 16g between the edges 16c, 16d, 16e and 16f comprising a plurality of receiving areas or pockets 64, 66, 68, 70, 72 and 74 receiving ballast or weight, such as sand, chain, steel, wood or the like. Each pocket 64-74 is defined by a material, such as material 76 (FIG. 20), that is sewn to interior area 16g with a stitch 78 as shown.

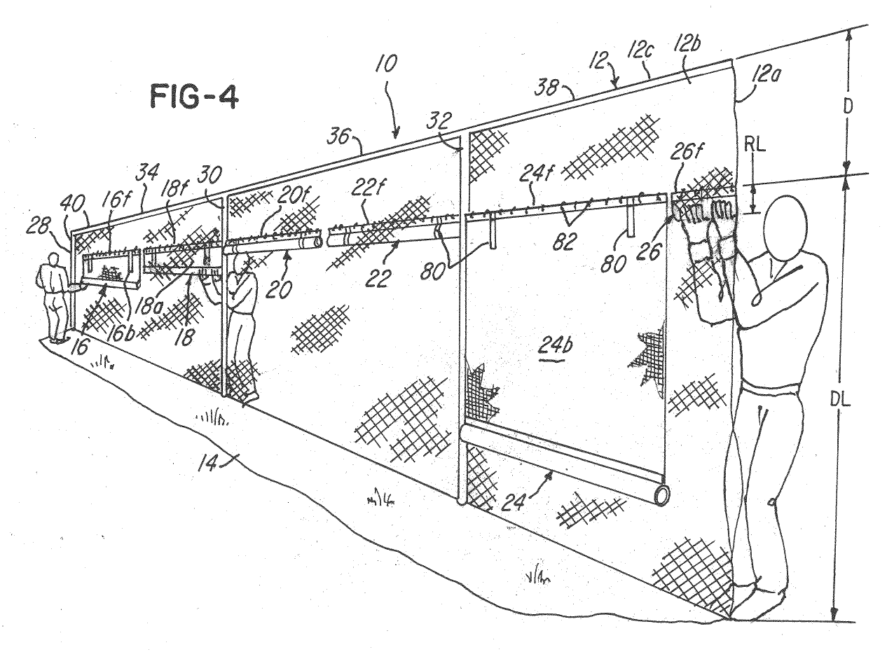

In the illustration, a plurality of first straps or fasteners 80 are provided and comprise tie straps as shown or may comprise other suitable means for securing the windscreen in a rolled-up or retracted position. For example, the at least one or plurality of first fasteners 80 may comprise Velcro@, snap fastener, bungee cord, rope or other means for retaining the windscreen in the rolled-up position, as illustrated in FIG. 4. Also, while the at least one or plurality of first fasteners 80 has been illustrated as being integrally formed or sewn into the windscreen 16 it should be appreciated that, although not shown, the windscreen 16 may comprise a non-integral fastener.

In one embodiment and as illustrated in FIG. 9, the at least one or plurality of first straps 80 may comprise elongated tie straps that are draped over the folded portion 16h and sewn directly thereto in order to form or provide a plurality of tie straps, such as straps 80, in opposed relation and adjacent to the first side 16a and the second side 16b, respectively, as illustrated FIG. 10. Note that the tie straps 80 (FIG. 10) provide a fastener or means for securing the windscreens 16-26 in the secured, retracted and locked position referred to earlier herein related to FIG. 4.

The at least one or plurality of first straps 80 enable the overall area or surface area, such as the interior area 16g (FIG. 7), of one or more of the windscreens 16-26 that is exposed directly to the wind to be decreased if desired. In this regard, note that the surface area of the windscreens 16-26 exposed to the wind can be reduced by retracting or rolling one or more of the windscreens 16-26 to a retracted or stored position, as illustrated by windscreens 20 and 22 in FIG. 4, which also facilitates reducing stress and forces on the fence 12. Note in FIG. 4 that the effective, wind-encountering area of the retracted windscreens 16-22 and 26 may be reduced by shortening the length from a fully deployed length DL (FIG. 4) to a retracted length RL in FIG. 4. The retraction may be accomplished, for example, by rolling the windscreen, such as windscreen 26, up and securing it in a stored or retracted position as shown in FIG. 4. Thus, it should be understood that the effective area of each windscreen 16-26 can be changed or even reduced, thereby reducing exposure to the wind W and stresses or forces on the fence 12.

As illustrated in FIGS. 9-12B, the system 10 also comprises at least one or a plurality of second fasteners 82 that are received in apertures defined by grommets 88. For example, note the grommets 89 and 90 (FIG. 9) define the apertures 84 and 86, respectively. To facilitate providing strength to the top edge 16f, the material or windscreen 16 may be folded or gathered upon itself to form the folded area 16h, as shown in FIG. 10, before the grommets are mounted or secured to the top edge 16f of windscreen 16. The at least one or a plurality of second fasteners 82 may include a split ring, wire-formed split ring, wire, hog wire, tie wrap, rope, hog ring, snap fastener, or other suitable means for securing the grommets or windscreen 16 to the fence 12, preferably, at its upper most or top edge 16f.

FIGS. 11-12B illustrate the at least one or a plurality of second fasteners 82 after it is situated in the grommet 89 associated with the aperture 84. The process of fastening the windscreen 16 onto the fence 12 will now be described.

As illustrated in FIG. 11 the second fastener 82 (a split ring in this example) is operatively received in the grommet 90 as shown such that a bottom curved or U-shaped portion 82a of the split ring 82 is received in and engages the grommet 90 as shown. A U-shaped portion 82c of the split ring 82 is situated in mounting relationship to at least one or a plurality of wires, such as wire 12d, that cooperate to form the fence 12. The second fastener 82 is moved in the direction of arrow A in FIG. 12A until the wire 12d engages and urges the U-shaped portion 82b of the at least one second fastener 82 from a closed position (FIG. 11) to an open position (FIG. 12A). After the split ring fastener 82 is opened as shown in FIG. 12A, the fastener 82 is moved relative to the wire 12d in the direction of arrow B in FIG. 12B until the wire 12d engages the top portion 82c of the at least one second fastener 82, whereupon the U-shaped portion returns to the closed position and the windscreen 16 becomes secured or fastened to the fence.

Advantageously, the fastening means or at least one second fastener 82 provides a system and means for fastening each of the grommets 88 to the fence 12. One feature of the embodiment being described is that the second fastener 82 can be fastened to the fence 12 using only one hand. This enables a single user, for example, to fasten the windscreens 16-26 to the fence 12 because the user can mount each second fastener 82 onto the fence 12 one at a time and without the need for one or more additional persons to separately hold the windscreen 16 in position during fastening.

As mentioned early herein, although one embodiment illustrates the use of the wire forms split ring illustrated FIGS. 11-12B, other means for fastening the windscreen 16 onto the fence 12 may be used, such as tie wraps, rope(s), wires, snap fasteners, hog wires, or the like. For example, FIG. 24 illustrates the windscreen 16 tied to the horizontal support 34 with individual plastic tie fasteners.

The system 10 and method provide means for protecting the area 14 from the wind W with at least one of the windscreens 16-26 and can facilitate reducing the size of the vertical posts or supports 28, 30 and 32 and horizontal supports 34, 36 and 38 used to construct the fence mentioned earlier. In this regard, note that stresses on the fence 12 are reduced because the windscreens 16-26 yield leeward and permit some or all air and wind to flow through the fence 12 after the wind reaches the predetermined velocity, rather than exert pressure against the fence 12. For example, a prior art chain link fence surrounding a tennis court (not shown) may comprise steel pipe vertical posts (not shown) having a gauge/diameter of 1.875 inches in diameter, 0.120 inch wall thickness or 11 gauge. The typical prior art windscreen would be attached to one side of the fence and would be able withstand a wind velocity up to a certain threshold. When used with a prior art windscreen, the fence 12 was capable of only withstanding winds up to about 45 mph before the wind force exerted so much pressure on the windscreen and fence that it caused the fence, the posts holding the fence or windscreen to fatigue and bend or become disformed or damaged. Thus, when the wind velocity exceeded the threshold, the wind force against the prior art fence and windscreen caused the vertical post, for example, to bend or become deformed. This caused damage to the fence, the windscreen and/or the supports for the fence. The non-repairable nature of the steel posts that were typically used with the chain link fence of the past made replacement necessary and expensive.

In contrast, a feature of the embodiment illustrated in FIGS. 1 and 2, for example, is that the one or more of the flexible sheet material windscreens 16-26 will yield downwind or leeward to a wind force in order to relieve stress on the fence 12, frame 40 and vertical posts or supports 28, 30 and 32. This facilitates allowing the fence 12 to withstand a higher wind velocity compared to prior art windscreens. This is particularly useful in areas where there can be high gusting winds because the system 10 will provide relief from high wind stresses that prior windscreens did not

Returning to FIGS. 1-3, note that the windscreens may be arranged such that their sides or vertical edges, such as edges 16c and 18c, are adjacent or abut so there is no gap distance GD, which is the distance GD between adjacent edged of adjacent windscreens 16-26. As illustrated in FIG. 17, however, the windscreens 16-26 may be arranged such that their edges, such as edges 20c and 22c of windscreens 22 and 24, respectively, are separated to define the gap distance (GD) between windscreens 22 and 24.

This feature of the embodiment shown in FIG. 3 is advantageous in that it permits system 10 to accommodate fences 12 of various sizes and reduces or eliminates the need for providing a windscreen of a custom size, specific or exact length or width dimension because the windscreens 16-26 may be overlapped (as shown by the overlapped areas 43 in FIG. 3) to accommodate fence 12 surface areas 42 (FIG. 2) of different dimensions.

In one embodiment, it is desirable that the windscreens 16-26 yield when the wind velocity equals or exceeds at least 25 mph, but the predetermined velocity at which the windscreens 16-26 yield may be selected in response to the environment and wind conditions in which the system 10 is used as described later herein.

A method for shielding the area 14 will now be described. In the illustration being shown, a determination is made of the typical wind speed or force that approaches the area 14 (FIG. 1). In response, the order in which the at least one or a plurality of windscreen 16-26 are to be place on the fence 12 is determined. The position of the windscreens 16-26 is also determined. After the order and position are determined, the plurality of fasteners 82 are used to fasten the plurality of grommets 88 and top edge, such as edge 16f of windscreen 16, of each windscreen to the fence 12 as illustrated in FIGS. 1-6, 9-12b, and 16-17. As mentioned earlier herein, each of the plurality of windscreens 16-26 comprise ballast or weight 52 of a predetermined amount. The windscreens 16-26 may be provided to the end users with the predetermined amount of weight 52 or it may be provided to the end user such that the end user can adjust or vary the amount of ballast or weight 52 in the receiving area 50 or area 51 of ballast container 53. As mentioned earlier, if a ballast container 53 is used, one or more of the removable end caps 55 and 57 referred to earlier for sealing the ends of the container 53 after ballast or weight 52 (FIG. 10) has been inserted therein.

It is important to note that each of the windscreens 16-26 will have at least a first side, such as first sides 16a, 18a, 20a, 22a, 24a and 26a (FIG. 1), situated adjacent to the fence 12 and a second side, such as second sides 16b, 18b, 20b, 22b, 24b and 26b, situated opposite thereto, respectively. The second sides 16b, 18b, 20b, 22b, 24b and 26b face away from the fence 12. The predetermined weights or ballast 52 situated in the windscreens 16-26 are selected such that the second sides 16b, 18b, 20b, 22b, 24b and 26b of the windscreens 16-26 will yield downwind or leeward away from the fence 12 when wind engages the first sides 16a, 18a, 20a, 22a, 24a and 26a with a predetermined velocity. This is illustrated in FIGS. 5-6 relative to the windscreens 16 and 18. Note in FIG. 5 that the first side 16a of windscreen 16 is adjacent to the fence 12 and the second side 16b faces away from the fence 12 in the illustration being shown. Likewise, the windscreen 18 comprises the first side 18a situated adjacent to the fence 12 and the second side 18b that faces away from fence 12. When the wind W approaches from the side 12a of fence 12 (as viewed in FIG. 5) the wind engages the second side 18b of the windscreen 18 and forces the windscreen 18 and first side 18a against the fence 12 as shown. Substantially simultaneously, the wind W engages the first side 16a of windscreen 16 and when the wind equals or exceeds the predetermined velocity, that windscreen 16 begins yielding downwind or leeward as shown, thereby facilitating, relieving or reducing the pressure or force against or on the fence 12.

Likewise, as wind W approaches from the left (as viewed in FIG. 6) in the example, the wind W engages the second side of 16b of windscreen 16 to force the first side 16a of windscreen 16 against the second side 12b of fence 12. Substantially simultaneously, the wind W engages the first side 18a of the windscreen 18 and when the wind equals or exceeds the predetermined velocity, the windscreen 18 begins to yield in a downwind or leeward direction as shown in FIG. 6.

As illustrated in FIG. 5, note that an angle of incidence \textcircled{-}₁ relative to the wind W is generally about ninety degrees before wind W reaches the predetermined velocity and before the windscreens 16 and 18 yield. In the illustration, the wind is shown encountering the first sides 16a and 18a at an angle of incidence \textcircled{-}₁ that is substantially perpendicular in the illustration to a plane P in which the fence lies. In the event the wind exceeds the predetermined velocity, such as 25 mph in one illustration, the windscreens 16-26 situated on the downward or leeward side of the fence 12 (side 12b in the illustration shown in FIG. 5) will yield as illustrated relative to windscreen 16 in FIG. 5. Note that the angle of incidence increases from \textcircled{-}₁ to \textcircled{-}₂ which facilitates reducing the force on fence 12 when compared to a system where the windscreens do not yield at all.

In the embodiment being described, the predetermined velocity may be at least 25 mph, but it could be higher or lower. This means that the windscreens 16-26 will remain substantially against the fence 12 at wind velocity less than 25 mph, thereby blocking or screening the area 14 (FIG. 1) from the wind W. When the wind W equals or exceeds the predetermined velocity, such as 25 mph in the illustration being described, then the one or more the windscreens 16-26 will yield downwind or leeward to the wind W in order to reduce stress and force against one or more of the windscreens 16-26 and the fence 12.

As mentioned earlier herein, the amount of weight or ballast 52 situated in each of the windscreens 16-26 will be provided or selected in response to a determination or estimation of the sustained predetermined velocity and wind direction, the material comprising the windscreen and other factors. Thus, when the predetermined velocity or threshold is selected to be greater than 50 mph in the illustration, a greater amount of ballast or weight 52 would be situated in the receiving area 50 defined by hem 46 or in area 51 of container 53 if a container 53 is used. Where it is desired to have the windscreens 16-26 yield at a lower wind velocity, then a less amount of predetermined ballast or weight 52 would be selected. The variability of the ballast or weight 52 is particularly useful because different fences have different diameter or gauge steel posts or supports, such as supports 28-38. For example, it may be desired to use less ballast or weight on a fence frame that is not capable of resisting much wind force and to use more ballast or weight on a stronger fence frame that is capable of resisting more wind force. While the windscreens 16-26 may be provided with a standard or predetermined amount of weight or ballast 52, that ballast or weight may be adjusted in response to the strength of the fence, the typical wind conditions, or wind forces encountered by the fence 12 and the like, thereby enabling the system 10 to be adjustable to respond or yield to different wind velocities.

Thus, it should be understood that while at least 25 mph is referred to in one embodiment described herein as a desired velocity threshold, this threshold or predetermined velocity may be established higher or lower depending upon the environment and application in which the system 10 is being used.

Referring now to FIGS. 1-4 and 16-17, notice that the inventors have found that it may useful, but not mandatory, to mount or fasten the windscreens 16-26 on the fence 12 at the predetermined distance D from a top edge 12c of fence 12. In the illustration shown in FIG. 1 for example, the predetermined distance D may be six inches in the embodiment being described, but that distance D could be larger or smaller if desired. Note in FIG. 24 that the windscreen 16-26 may be mounted so there is zero distance D between top edge 16f and edge 16d. The distance D may also change depending on the overall height of the fence 12. By lowering the top edge, such as edge 16f on windscreen 16, to the predetermined distance D from the top edge 12c, the force or moment arm on the fence 12 is reduced from the distance L2 (FIG. 2) to the distance L3. This reduction in the moment arm further facilitates reducing the force on the fence 12 relative to any windscreens that do not yield leeward, such as windscreen 18, 22, and 26 as shown in illustration. Thus another feature of the embodiment illustrated and described relative to FIGS. 1 and 2, is that the windscreens 16-26 may be dropped below the top edge 12c of the fence 12 in order to further facilitate reducing the force on the fence 12.

It should be understood that although the embodiments illustrated show each of the top edges 16f, 18f, 20f, 22f, 24f and 26f (FIG. 1) of the windscreens 16-26 being generally collinear or situated at substantially an equal distance from the top edge 12c of fence 12, it should be understood that each of the windscreens 16-26 may be situated at the same distance D or at different distances so that the distance D varies or is different for a plurality of the windscreens 16-26. Also, it should be understood the windscreens 16-26 may be situated so that their top edges, such as edge 16f of windscreen 16, are not collinear.

The system 10 further comprises the at least one or a plurality of first fasteners 80 that provide other means for reducing the exposed surface area of the windscreens 16-26 relative to the wind. Thus, the effective surface area exposed to an oncoming wind may be reduced for one or more of the windscreens 16-26 to further facilitate reducing overall force or moment applied that the fence 12 experiences when the wind engages it. Note that each of the windscreens 16-26 may be secured to the stored or rolled-up position (as illustrated by windscreen 20 in FIG. 4) and the effective area that each windscreen exposed to the wind may be either different or the same. In the illustration of FIG. 4, some of the windscreens 16-26 are rolled or stored to a fully deployed position while others, such as windscreens 16, 18, and 26, are illustrated in a less than fully retracted or rolled-up position. This is particularly useful when known high winds, such as a hurricane, are approaching the area 14 in which the user can retract or secure windscreens 16, 20 and 24 in the rolled-up or retracted position.

In the illustration being described, the windscreens 16, 18, and 26 are shown retracted at different positions. Thus, although not shown, the straps may be provided such that one or more of the windscreens 16-26 may be rolled up and secured to different lengths (FIG. 4).

As mentioned earlier herein, not only may the windscreens 16-26 be placed at different heights relative to each other and relative to the top edge 12c of fence 12, they may also be placed such that they overlap a common portion of the fence 12, as illustrated in FIG. 3. Also, the windscreens 16-26 may be situated directly adjacent each other as illustrated in FIGS. 1 and 2 or they may be situated such that adjacent edges do not meet or overlap or define the gap distance GD mentioned earlier and as illustrated in FIGS. 2 and 17. In this regard, notice that the edge 22c of windscreen 22 in FIG. 17 is situated the gap distance GD from the edge 20c of windscreen 20. In the embodiment being described, this gap distance GD may be a few inches or alternatively it could be many feet or meters.

In the embodiment being described, each of the plurality of windscreens 16-26 is made from a mesh material (or screened material, such as 12×18, vinyl coated polyester scrim and 1000 denier material, but it should be understood that other suitable mesh or windscreen materials may be used. For example, the material could be a solid polyvinyl material or any flexible, wind or weather resistant flexible sheet or film, such as Mylar® or the like. It should be understood that the material selected could be a mesh fabric that permits air to pass through or it could be a material or fabric that does not permit air to pass through. The type of material may vary depending upon such factors as the strength of the fence 12, the typical wind conditions, wind velocity, wind direction, area of the fence 12 covered, mounting height and the like. Moreover, each of these windscreens 16-26 may comprise indicia, such as advertising indicia 100 (FIG. 24) or other information signage if desired.

Also, each of the windscreens 16-26 are illustrated as being generally rectangular or square, but it should be understood they could comprise any predetermined configuration or shape, such as any polygonal shape, multi-sided shape, circular or elliptical shape or any combination thereof. For example, FIGS. 22A and 22B illustrate windscreen 16 comprising the circular or elongated shapes.

The illustrations shown in FIGS. 1-17 and 19-22 illustrate the ballast or weight provided in the hem 46. An alternate embodiment, illustrated in FIG. 18, shows a pocket, receiving pocket or area 91 provided by a separate material 92 that is affixed to a windscreen material, such as windscreen 16 (without the hem 46), with stitches 96. Although not shown, the separate windscreen may be non-permanently secured using a suitable detachable fastener (not shown) such as a snap fastener (not shown) or Velcro® fastener (not shown).

While the system and method herein described, and the form of apparatus for carrying this method into effect, constitute preferred embodiments of this invention, it is to be understood that the invention is not limited to this precise system and method and form of apparatus, and that changes may be made in either without departing from the scope of the inventions, which is defined in the appended claims.

What is claimed is:

1. A wind shielding system for mounting on a fence having a first side and a second side, said wind shielding system comprising:
a first flexible sheet material having a first ballast comprising a first predetermined weight; and
a second flexible sheet material having a second ballast comprising a second predetermined weight;
said first and second flexible sheet material being arranged on the fence in a predetermined order to facilitate protecting an outdoor area from wind.

2. The wind shielding system as recited in claim 1 wherein said predetermined order comprises a staggered configuration wherein said first and second flexible sheet material are arranged on said first and second sides, respectively.

3. The wind shielding system as recited in claim 1 wherein said first and second flexible sheet material at least partially overlap each other.

4. The wind shielding system as recited in claim 2 wherein said first and second flexible sheet material at least partially overlap a portion of the fence.

5. The wind shielding system as recited in claim 1 wherein said predetermined order comprises a non-staggered configuration wherein said first and second flexible sheet material are arranged on the same first side or second side of the fence.

6. The wind shielding system as recited in claim 1 wherein approximately one-half of a total area of each of said first side and said second side are covered by said first and second flexible sheet material.

7. The wind shielding system as recited in claim 1 said predetermined order comprises a configuration wherein a plurality of said windscreens are arranged on said first side and said second side with a gap of a predetermined gap distance exists between adjacent edges of adjacent ones of said plurality of windscreens.

8. The wind shielding system as recited in claim 1 wherein said first and second flexible sheet material each comprise a first side situated adjacent to the fence and a second side situated opposite said first side, said first and second predetermined weights being selected such that said second sides of said first and second flexible sheet material yield leeward away from the fence when wind engages said first side.

9. The wind shielding system as recited in claim 2 wherein said first and second flexible sheet material each comprise a first side situated adjacent to the fence and a second side situated opposite said first side, said first and second predetermined weights being selected such that a downstream one of said first or second flexible sheet material yields to decrease the effective exposed windscreen area of the wind shielding system.

10. The wind shielding system as recited in claim 8 wherein said first and second flexible sheet material decreases the effective exposed windscreen area when a wind velocity is at least 25 mph.

11. The wind shielding system as recited in claim 1 wherein said system comprises N number of flexible sheet materials arranged in a predetermined order on the fence.

12. The wind shielding system as recited in claim 11 wherein said predetermined order comprises every other one of said N number of flexible sheet materials are arranged on opposite sides of the fence.

13. The wind shielding system as recited in claim 11 wherein said predetermined order is such that a first number of said N number of flexible sheet materials are arranged on said first side and a second number of said N number of flexible sheet materials are arranged on said second side of the fence.

14. The wind shielding system as recited in claim 11 wherein said N number of flexible sheet materials are arranged in equal numbers on said first and second sides of the fence.

15. The wind shielding system as recited in claim 11 wherein said N number of said first and second flexible sheet materials are arranged in unequal numbers on said first and second sides of the fence.

16. The wind shielding system as recited in claim 1 wherein each of said first and second flexible sheet material comprises an edge, said system further comprising:
at least one fastener adapted to detachably fasten said edge at a predetermined location on the fence.

17. The wind shielding system as recited in claim 16 wherein said edge is a top edge of said first and second flexible sheet material.

18. The wind shielding system as recited in claim 16 wherein said predetermined location is associated with a top of the fence.

19. The wind shielding system as recited in claim 16 wherein said predetermined location is below a top of the fence by a predetermined distance.

20. The wind shielding system as recited in claim 19 wherein said predetermined distance is at least 6 inches.

21. The wind shielding system as recited in claim 1 wherein each of said first and second flexible sheet material comprises at least one second fastener for fastening and retaining said first and second flexible sheet material, respectively, in a rolled-up configuration.

22. The wind shielding system as recited in claim 21 wherein said at least one second fastener comprises at least one tie.

23. The wind shielding system as recited in claim 16 wherein said at least one fastener comprises a tie wrap, rope, split ring, hog ring, a snap fastener, a wire-formed split ring, a wire, or a hog wire.

24. The wind shielding system as recited in claim 16 wherein said at least one fastener is a wire-formed split ring.

25. The wind shielding system as recited in claim 1 wherein at least one of said first and second flexible sheet material comprises a fabric that permits air to pass therethrough.

26. The wind shielding system as recited in claim 1 wherein at least one of said first and second flexible sheet material comprises a fabric that does not permit air to pass therethrough.

27. The wind shielding system as recited in claim 1 wherein said first and second predetermined weights are provided by said weights of said first and second sheet materials, respectively.

28. The wind shielding system as recited in claim 1 wherein said first flexible sheet material comprises a first portion that is fastened to the fence and does not yield to said wind, while said second flexible sheet material does yield to said wind.

29. The wind shielding system as recited in claim 1 wherein each of said at least one first and second flexible sheet material comprises at least one ballast pocket.

30. The wind shielding system as recited in claim 29 wherein said at least one ballast pocket is adapted to receive at least one ballast unit.

31. The wind shielding system as recited in claim 29 wherein said at least one ballast pocket is located on a bottom edge of each of said first and second flexible sheet materials.

32. The wind shielding system as recited in claim 29 wherein said at least one ballast pocket is located on at least one vertical edge of said first and second flexible sheet material.

33. The wind shielding system as recited in claim 30 wherein said ballast unit is a container adapted to receive a preselected amount of ballast material.

34. The wind shielding system as recited in claim 30 wherein a weight of said first flexible sheet material provides said first predetermined weight and a weight of said second flexible sheet material provides said second predetermined weight.

35. The wind shielding system as recited in claim 33 wherein said ballast material is sand, chain, pipe, gravel, concrete, earth or metal.

36. The wind shielding system as recited in claim 29 wherein said at least one ballast pocket is provided by a hem formed in a portion of said first or second flexible sheet material onto itself.

37. The wind shielding system as recited in claim 29 wherein said first and second flexible sheet material comprise a top edge and a bottom edge; said at least one ballast pocket being formed adjacent said bottom edge.

38. The wind shielding system as recited in claim 1 wherein each of said first and second flexible sheet material comprise a plurality of ballast areas located interior of edges of said first and second flexible sheet material.

39. The wind shielding system as recited in claim 1 wherein said first and second predetermined weights comprise sand.

40. The wind shielding system as recited in claim 1 wherein each of said first and second flexible sheet material comprise a ballast pocket having at least one ballast comprising sand, a chain or pipe, gravel, concrete, earth or metal.

41. The wind shielding system as recited in claim 1 wherein at least one of said first and second flexible sheet material comprise ballast situated at a plurality of locations.

42. The wind shielding system as recited in claim 1 wherein said first and second flexible sheet material are joined to form a continuous windscreen.

43. The wind shielding system as recited in claim 1 wherein said first and second flexible sheet material comprise a predetermined shape.

44. The wind shielding system as recited in claim 43 wherein said predetermined shape is polygonal, multi-sided, circular or elliptical.

45. The wind shielding system as recited in claim 1 wherein said predetermined order comprises a first predetermined number of a plurality of said flexible sheet material on said first side and a second predetermined number of said plurality of flexible sheet material on said second side, wherein said first and second predetermined numbers are equal.

46. The wind shielding system as recited in claim 1 wherein said predetermined order comprises a first predetermined number of said first flexible sheet material on said first side and a second predetermined number of said second flexible sheet material on said second side, wherein said first and second predetermined numbers are not equal.

47. The wind shielding system as recited in claim 1 wherein said first and second flexible sheet material comprise generally the same dimensions.

48. The wind shielding system as recited in claim 1 wherein said first and second flexible sheet material comprise different dimensions.

49. The wind shielding system as recited in claim 1 wherein said first and second flexible sheet material comprise different shapes.

50. The wind shielding system as recited in claim 1 wherein said first and second flexible sheet material are rectangular or square.

51. The wind shielding system as recited in claim 1 wherein at least one of said first and second flexible sheet material are circular or elliptical.

52. The wind shielding system as recited in claim 1 wherein each of said first and second flexible sheet materials comprises an open weave that allows the passage of air therethrough.

53. The wind shielding system as recited in claim 1 wherein at least one of said first or second flexible sheet materials comprise indicia thereon.

54. The wind shielding system as recited in claim 1 wherein each of said first and second flexible sheet materials comprises a top edge and a bottom edge,
said first and second predetermined weight being situated near said bottom edge of said first and second flexible sheet materials, respectively;
said first and second flexible sheet materials also being fastened to said fence at said top edge.

55. The wind shielding system as recited in claim 54, where said first and second flexible sheet materials are fastened to said fence with at least one fastener only at said top edge.

56. A system for screening an area from winds comprising a plurality of windscreens;
at least one support on which said plurality of windscreens may be mounted such that at least one of said plurality of windscreens yields to a wind while others of said plurality of windscreens do not.

57. The system as recited in claim 56 wherein each of said plurality of windscreens comprise a preselected amount of weight.

58. The system as recited in claim 57 wherein said weight is located in a hem of each of said plurality of windscreens.

59. The system as recited in claim 56 wherein said plurality of windscreens are not all located on a same side of said support.

60. The system as recited in claim 56 wherein said support is a fence.

61. The system as recited in claim 59 wherein said support is a fence.
